(19) United States
(12) Patent Application Publication
(10) Pub. No.: US 2017/0025984 A1
(43) Pub. Date: Jan. 26, 2017

(54) MULTI-MODULE THERMOVOLTAIC POWER SOURCE

(71) Applicant: The Regents of the University of California, Oakland, CA (US)

(72) Inventor: Eli Yablonovitch, Oakland, CA (US)

(21) Appl. No.: 15/302,406

(22) PCT Filed: Apr. 7, 2015
(86) PCT No.: PCT/US15/24771

§ 371 Date: Oct. 6, 2016

Related U.S. Application Data
(60) Provisional application No. 61/976,445, filed on Apr. 7, 2014.

(51) Int. Cl. H02S 10/30; H02S 10/40

(52) U.S. Cl. CPC H02S 10/30; H02S 10/40

(57) ABSTRACT

A thermophotovoltaic (TPV) system includes multiple thermo-photovoltaic modules that provide power to an application. Different thermo-photovoltaic modules provide different power levels to the application. Electronics can activate a portion of the thermo-photovoltaic modules in response to the power requirements of the application.

### RELATED APPLICATIONS

This application claims the benefit of U.S. Provisional patent application Ser. No. 61/976,445, filed on Apr. 7, 2014, which is incorporated herein in its entirety.

### FIELD

The present invention relates to Power Sources and more particularly to thermophotovoltaic power sources.

### BACKGROUND

Thermophotovoltaic (TPV) power sources are desirable in a number of applications. For instance, these power sources are highly desirable for transportation applications since they have no moving parts, are very lightweight, and more efficient than diesel or gasoline engines. However, since a thermophotovoltaic power source is most efficient at high temperatures, the power generated by a thermophotovoltaic power source is not easily throttled in response to the variable loads required by transportation applications. Accordingly, there is a need for an improved power source that makes use of thermophotovoltaics.

### SUMMARY

A thermophotovoltaic (TPV) system includes multiple thermophotovoltaic modules that provide power to an application. Different thermo-photovoltaic modules provide different power levels to the application. Modules that provide different power levels can have different sizes.

Another embodiment of the thermophotovoltaic (TPV) system has multiple thermophotovoltaic modules in electrical communication with electronics. The electronics monitor power requirements of an application powered by the modules. Additionally, the electronics identify a portion of the modules in response to the power requirements of the application. The electronics can use the identified portion of the modules to power the application.

The disclosure provides a system, comprising multiple thermo-photovoltaic modules providing power to an application, different thermo-photovoltaic modules providing different power levels to the application. In one embodiment, a first portion of the modules has a different physical size than a second portion of the modules. In another embodiment, the modules each include multiple components positioned in a chamber and the volume of the chamber is different for different modules. In yet another embodiment, the modules each includes an emitter and the size of the emitter is different for different modules.

The disclosure also provides a system, comprising multiple thermo-photovoltaic modules in electrical communication with electronics, the electronics monitor power requirements of an application to be powered by the modules, and the electronics identify a portion of the modules in response to the power requirements of the application. In one embodiment, the electronics use the identified portion of the modules to provide power to the application while modules that were not identified are not used to power the application. In yet a further embodiment, the electronics use the identified portion of the modules to provide power to the application in response to identification of the modules. In another embodiment, the portion of the modules identified by the electronics changes in response to the power requirements of the application. In still another embodiment, a first portion of the modules is configured to generate electrical power at a different level than a second portion of the modules. In a further embodiment, the first portion of the modules has a different physical size than the second portion of the modules. In another embodiment, the modules each include multiple components positioned in a chamber and the volume of the chamber is different for different modules. In yet another embodiment, the modules each includes an emitter and the size of the emitter is different for different modules. In another embodiment, the application is an electrical system of a car. In yet another embodiment, at least a portion of the modules are each associated with an index j that varies from 1 to N and module j is configured to provide a power level equal to 2^{(j-1)}P where P is a pre-determined power level.

The disclosure also provides a method of powering an application, comprising identifying one or more thermo-photovoltaic modules from among a group of modules; and using the identified modules to power an application. In one embodiment, the method further comprises changing the identified modules in response to changes in a power requirement of the application. In yet another embodiment, the method further comprises identifying a portion of the modules from among the group of modules after identifying the one or more modules, the identified portion of the modules being different from the one or more identified modules; changing the modules that power the application from the one or more identified modules to the identified portion of the modules. In a further embodiment, different modules in the group of modules have a different physical size. In yet another embodiment, the modules each include multiple components positioned in a chamber and the volume of the chamber is different for different modules. In still another embodiment, a first portion of the modules included in the identified modules generates electrical power at a different level than a second portion of the modules.

A method of operating a thermophotovoltaic (TPV) system includes identifying a portion of the thermophotovoltaic modules from among a group of thermophotovoltaic modules. The method also includes using the identified modules to power an application.

### BRIEF DESCRIPTION OF THE FIGURES

FIG. 1 is a schematic of a regenerative thermophotovoltaic (TPV) module.

FIG. 2 is a schematic illustration of a thermophotovoltaic system.

FIG. 3 is a schematic of an example of the thermophotovoltaic system illustrated in FIG. 2.

### DESCRIPTION

As used herein and in the appended claims, the singular forms “a,” “and,” and “the” include plural referents unless the context clearly dictates otherwise. Thus, for example, reference to “a photovoltaic cell” includes a plurality of such photovoltaic cells and reference to “the housing” includes reference to one or more housings, and so forth.

Unless defined otherwise, all technical and scientific terms used herein have the same meaning as commonly understood to one of ordinary skill in the art to which this disclosure belongs. Although methods and materials similar or equivalent to those described herein can be used in the practice of the disclosed methods and compositions, the exemplary methods, devices and materials are described herein.

Also, the use of “or” means “and/or” unless stated otherwise. Similarly, “comprise,” “comprises,” “comprising” “include,” “includes,” and “including” are interchangeable and not intended to be limiting.

It is to be further understood that where descriptions of various embodiments use the term “comprising,” those skilled in the art would understand that in some specific instances, an embodiment can be alternatively described using language “consisting essentially of” or “consisting of.”

Thermophotovoltaic (TPV) systems produce electricity via the use of an emitter that thermally radiates photons, which can be subsequently converted into electron-hole pairs within a photovoltaic (PV) medium. These electron-hole pairs can be conducted to electrical leads within the system to produce a current. Because they are solid-state devices, TPV systems have the potential for relatively high reliabilities, relatively small form factors (e.g., meso- and micro-scales), and relatively high energy densities compared to, for example, traditional mechanical engines. However, many emitters within TPV systems emit a large amount of thermal photons with energies below the electronic bandgap of the TPV cell, which are absorbed as waste heat within the system. In many cases, this phenomenon produces TPV system efficiencies well below those of their mechanical counterparts operating at similar temperatures. For these reasons, among others, there exists a need for more effective systems and methods for generating energy using thermophotovoltaic cells.

A thermophotovoltaic (TPV) system includes a group of (TPV) modules that power an application. Different TPV modules provide different levels of power to the application. The modules that provide different levels of power can have different sizes. Electronics can monitor the power requirements of the application and identify a portion of the modules that are suitable for powering the application at that time. The electronics can then use the identified modules to power the application. The selection of modules that power the application can be varied in response to the power requirements of the application. For instance, the selection of modules that is suitable for providing the current power requirements of the application can be used to power the application and can then be changed as the power requirements of the application change. As a result, the power output from the system is easily changed in response to the variable loads required by applications such as vehicle electrical systems. Accordingly, the system has the advantage of thermophotovoltaics (TPV) while still being easily throttled.

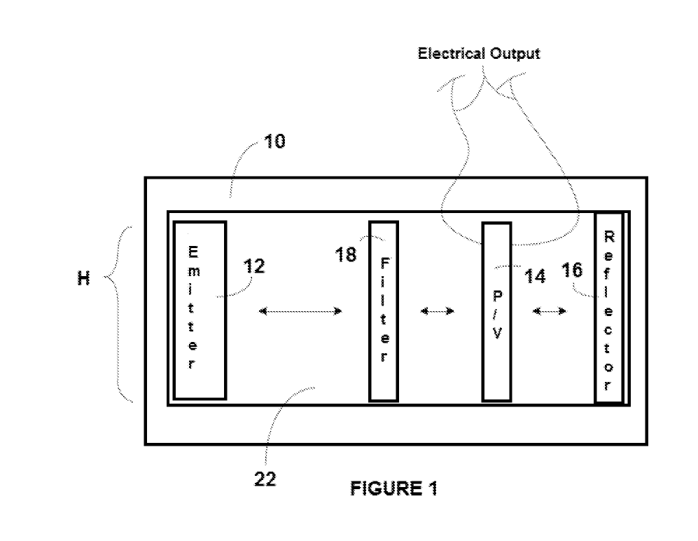

FIG. 1 is a schematic of a regenerative thermophotovoltaic (TPV) module. The module includes TPV components in a housing 10. The TPV components include a thermal emitter 12 that acts as a source of light radiation. During operation, the emitter 12 is heated such that the emitter 12 produces electromagnetic radiation such as thermal radiation that includes light. For instance, the emitter 12 can be heated to a temperature where spontaneous emission of photons due to thermal motion of charges in the emitter 12 is achieved. The photons emitted by the emitter 12 are typically within a TPV wavelength range. For instance, TPV emitters 12 generally emit photons in the infrared and near-infra red wavelength range. Suitable emitters 12 include, but are not limited to, solid emitters such as metal emitters and ceramic emitters. A variety of mechanisms can be used to heat the emitter. Suitable mechanisms for heating the emitter include, but are not limited to, combustion, solar heat, and nuclear or radioactive heat.

The TPV components also include one or more photovoltaic devices 14 positioned to receive the thermal radiation emitted from the emitter 12 and convert the received thermal radiation to electrical energy. While the photovoltaic device 14 can make use of wavelengths that are shorter than the wavelengths in the TPV wavelength range, the receipt of these wavelengths by the photovoltaic device 14 can undesirably cause the photovoltaic device 14 to generate heat. Suitable photovoltaics for use in a TPV module include, but are not limited to, semiconductor devices such as photovoltaic diodes including single-junction and multi-junction tandem photovoltaic diodes.

The TPV components can optionally include a reflector 16 configured to reflect thermal radiation that is transmitted through the photovoltaic device 14 back through the photovoltaic device 14 to the thermal emitter 12. As is evident from FIG. 1, the photovoltaic device 14 can be positioned between the emitter 12 and the reflector 16. Additionally or alternately, the TPV components can optionally include a filter 18 between the photovoltaic device 14 and the emitter 12. The filter 18 can be configured to transmit wavelengths within the TPV wavelength range and to return wavelengths outside of the TPV wavelength range to the emitter 12. In one example of a module that includes a filter 18 and a reflector 16, the filter 18 transmits wavelengths within the wavelength range and reflects, or effectively reflects, light with wavelengths lower than the wavelength in the TPV wavelength range and the reflector 16 reflects at least wavelengths above the TPV wavelength range.

Although not illustrated in FIG. 1, the TPV module can be constructed such that one or more elements selected from the group consisting of the filter 18, photovoltaic device 14, and reflector 16 surrounds the emitter 12.

A variety of applications that can be powered by the disclosed TPV system have power demands that vary with time. However, a TPV module can become less efficient when providing the lower power levels that may be required during operation of these applications. For example, thermophotovoltaic generator is most efficient at a high fixed temperature of heat radiation from an emitter source. Such TPVs do not throttle easily for the variable loads that transportation requires. Thus, a multi-module approach is needed for transportation that requires some high power TPV modules that can be on standby, and some low power TPV modules that would serve under smaller loads. Such a system provides power across the full range of application requirements by using TPV modules that are configured to output electrical power in different operational ranges.

The power levels included in the operational range of a TPV module can be changed by changing the size of the TPV module. By altering the size of a TPV module, changes in the level of power in the operational range of a TPV module can be obtained. For instance, the TPV components illustrated in FIG. 1 (emitter 12, photovoltaic device 14, optional filter 18, and optional reflector 16) each have a height (labeled H) in FIG. 1. Increasing the height of one or more of the TPV components increases the power that is efficiently output by the TPV module. For instance, increasing the height of the emitter 12 provides a larger source of photons and accordingly increases the number of photons that are converted to electrical power per unit time. The increased photon conversion rate results in an increased output power level for the module. Accordingly, TPV modules of different sizes and/or different output power levels have different sized emitters 12. The sizes (or height) of the other components can be changed to match the change in size of the emitter 12. For instance, when the height of the emitter 12 is increased, the height of the photovoltaic device 14 can be increased to increase the surface area of the photovoltaic device 14 that receives photons from the emitter 12.

As is evident in FIG. 1, all or a portion of the TPV components are positioned in a chamber 22 that is fully or partially defined by the housing 10 or is fully or partially defined by a combination of the housing and the reflector. For instance, the emitter 12, one or more photovoltaic devices 14, filter 18 (when present), and reflector 16 (when present) can be positioned in a chamber defined by the housing. Alternately, the emitter 12, one or more photovoltaic devices 14, and filter 18 (when present) can be positioned in a chamber defined by the housing and reflector 16. The chamber 22 walls are generally placed close to the TPV components to reduce the average number of chamber 22 wall reflections that a photons experiences before being incident of the photovoltaic device 14. As a result, changing the size of the one or more TPV components generally results in a change to the volume of the chamber 22. Accordingly, TPV modules configured to provide different power levels typically have chambers 22 with different volumes. The change in the volume of the chamber 22 traditionally translates into a change in the size of the housing 10. As a result, TPV modules configured to provide different power levels typically have chambers 22 with different volumes.

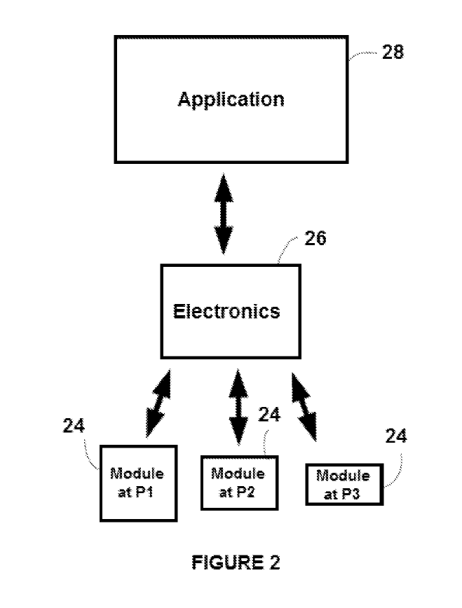

FIG. 2 is a schematic illustration of a thermophotovoltaic system that includes TPV modules 24 wherein each TPV module 24 has a different operational range. Each of the modules 24 is configured to provide a different power level. For instance, each of the different modules 24 can be configured such that the range of power levels at which the module 24 efficiently provides power is different. Since the level of power that a TPV module 24 can be changed by changing the size of the TPV module 24, the TPV modules 24 with lower levels of power in their operational range are illustrated as being smaller in size.

Each of the TPV modules 24 is in electrical communication with control electronics 26. The control electronics 26 are in electrical communication with an application to be powered by the TPV modules 24. During operation of the system, the electronics 26 periodically or continuously monitor the power requirements of the application 28 and identify the TPV module 24 or the combination of TPV modules 24 that can most efficiently provide the required power. The electronics 26 then operate the TPV modules 24 such that the identified thermophotovoltaic modules 24 provide the power required by the application 28. As a result, the TPV module 24 or combination of TPV modules 24 that can most efficiently power the application 28 are used to power the application 28. For instance, at times when the power requirements of an application 28 are below the power level that a particular TPV module 24 is configured to provide, the electronics 26 can reconfigure the system such that a TPV module 24 or a combination of TPV modules configured to provide a lower power level provides the required power. Alternately, at times when the power requirements of an application 28 are above the power level that a particular TPV module 24 is configured to provide, the electronics 26 can reconfigure the system such that a TPV module 24 or a combination of TPV modules configured to provide a higher power level provides the required power.

When a thermophotovoltaic module 24 is not providing the power required by the application 28, the electronics 26 can turn the thermophotovoltaic module 24 or a portion of the thermophotovoltaic modules 24 off, on standby, or electrically disconnect the thermophotovoltaic module(s) 24 from the application 28. As an example of a thermophotovoltaic module 24 that is turned off, the emitter 12 can be allowed to cool to a standby temperature or to the temperature of the ambient environment in which the thermophotovoltaic module 24 is positioned. As an example of a thermophotovoltaic module 24 that is in a standby mode, the electronics 26 can cause the temperature of the emitter 12 to be maintained somewhere between the operational temperature of the emitter 12 and the temperature of the ambient environment in which the thermophotovoltaic module 24 is positioned.

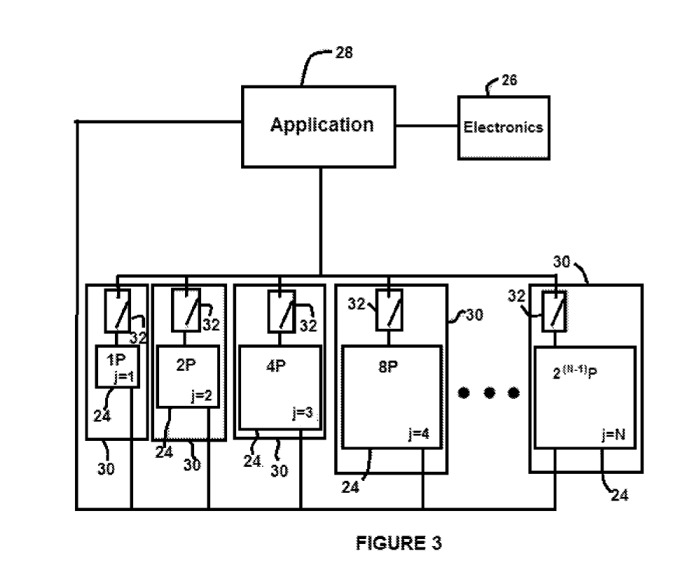

FIG. 3 illustrates one example of the modular TPV system. The system includes multiple different TPV modules 24. The system includes N modules 24 with each module 24 numbered j=1 through N. In some instances, N is equal to 2, 3, 4, or 5 or more. The modules 24 are connected in series of branches 30 that each includes one of the modules 24 connected in series with a switch 32. The branches in series or in parallel with one another. FIG. 3 illustrates the branches connected in parallel. The output of the parallel connected branches powers an application 28. The electronics 26 are in communication with the application 28 so as to monitor the power requirements of the application 28. Although not evident from FIG. 3, the electronics 26 are also in communication with each of the switches 32 so as to control the switches 32. For instance, the electronics 26 select the one or more modules 24 that provide power to the application 28 by opening and closing the appropriate combination of switches 32.

The modules 24 are each configured to provide a different level of output power. For instance, each of the modules 24 can have a different operational range. The operational range of the jth power module 24 includes a power level of 2^{(j-1)}P where P is a pre-determined power level. Accordingly, each of the modules 24 can be operated so as to provide an output power level of 2^{(j-1)}P. In a variety of different applications, a suitable value for P includes, but is not limited to, a power level greater than 100 Watt or 1Mwatt, or less than 100 Watt or 1Mwatt.

The geometric series of 2^{(j-1)}P allows the modules 24 to be combined so as to achieve any power level in the range from P to (2^{N}−1)P at intervals of 1P. For instance, when N=3, the electronics 26 can operate the switches 32 to provide power levels of 1P, 2P, 3P, 4P, 5P, 6P, or 7P. Accordingly, the electronics 26 can identify the one or more modules 24 that are suitable for providing the current power demands of the application 28. As an example, when electronics 26 determine that an application 28 requires a power level of αP, the electronics can compare the power levels that can be provided by the different combinations of modules to αP and identify the one or more modules that provides the power level closest to αP. As another example, when electronics 26 determine that an application 28 requires a power level of αP, the electronics 26 can round α to the nearest integer (Int.) and then identify the combination of modules 24 that provide the power level Int.xP. In response to identifying the one or more modules 24 that can efficiently provide the power requirements for the application 28, the electronics 26 can operate the switches 32 so the identified modules 24 provide electrical power to the application 28. As the value of α changes in response to the continued operation of the application 28, the one or more modules 24 that are identified by the electronics 26 will change. In response to that change, the electronics 26 will change the one or more modules 24 that are providing power to the application 28.

Although FIG. 2 and FIG. 3 illustrates the TPV modules 24 as each being configured to provide different power levels, the system can include multiple TPV modules 24 that are each configured to provide the same power level.

A suitable application 28 for being powered by the TPV system is a vehicle configured to transport people and/or cargo. As a particular example, the TPV system can recharge the batteries in a hybrid vehicle such as a car. The use of the TPV system to power the electrical system of a vehicle such as a car is very attractive because the TPV system requires no moving parts, is very lightweight, and can be considerably more efficient than diesel or gasoline engines. However, the variable power requirements of transportation does not permit efficient use of a single module 24. The use of the TPV system allows the one or more modules 24 that can most efficiently provide the power to the application 28 to be selected and used to power the vehicle.

The electronics 26 can include or consist of any suitable control device for performing the functions and processes as described herein. For example, the electronics 26 can include or consist of a processor for executing programming instructions stored in a memory, e.g., a microprocessor, such as an ARM7, or a digital signal processor (DSP), or it can be implemented as one or more application specific integrated circuits (ASICs), field programmable gate arrays (FPGAs), complex programmable logic devices (CPLDs), discrete logic, software, hardware, firmware or any suitable combination thereof.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising
multiple thermo-photovoltaic modules providing power to an application, different thermo-photovoltaic modules providing different power levels to the application.

2. The system of claim 1, wherein a first portion of the modules has a different physical size than a second portion of the modules.

3. The system of claim 1, wherein the modules each include multiple components positioned in a chamber and the volume of the chamber is different for different modules.

4. The system of claim 1, wherein the modules each includes an emitter and the size of the emitter is different for different modules.

5. A system, comprising
multiple thermo-photovoltaic modules in electrical communication with electronics,
the electronics monitor power requirements of an application to be powered by the modules, and
the electronics identify a portion of the modules in response to the power requirements of the application.

6. The system of claim 5, wherein the electronics use the identified portion of the modules to provide power to the application while modules that were not identified are not used to power the application.

7. The system of claim 6, wherein the electronics use the identified portion of the modules to provide power to the application in response to identification of the modules.

8. The system of claim 6, wherein the portion of the modules identified by the electronics changes in response to the power requirements of the application.

9. The system of claim 6, wherein a first portion of the modules is configured to generate electrical power at a different level than a second portion of the modules.

10. The system of claim 9, wherein the first portion of the modules has a different physical size than the second portion of the modules.

11. The system of claim 6, wherein the modules each include multiple components positioned in a chamber and the volume of the chamber is different for different modules.

12. The system of claim 6, wherein the modules each includes an emitter and the size of the emitter is different for different modules.

13. The system of claim 5, wherein the application is an electrical system of a car.

14. The system of claim 5, wherein at least a portion of the modules are each associated with an index j that varies from 1 to N and module j is configured to provide a power level equal to 2^{(j-1)}P where P is a pre-determined power level.

15. A method of powering an application, comprising:
identifying one or more thermo-photovoltaic modules from among a group of modules; and
using the identified modules to power an application.

16. The method of claim 15, further comprising:
changing the identified modules in response to changes in a power requirement of the application.

17. The method of claim 15, further comprising:
identifying a portion of the modules from among the group of modules after identifying the one or more modules, the identified portion of the modules being different from the one or more identified modules;
changing the modules that power the application from the one or more identified modules to the identified portion of the modules.

18. The method of claim 15, wherein different modules in the group of modules have a different physical size.

19. The method of claim 15, wherein the modules each include multiple components positioned in a chamber and the volume of the chamber is different for different modules.

20. The system of claim 15, wherein a first portion of the modules included in the identified modules generates electrical power at a different level than a second portion of the modules.
